(19) United States
(12) Patent Application Publication
(10) Pub. No.: US 2003/0098867 A1
(43) Pub. Date: May 29, 2003

(54) Method for using local memory of graphics card as extensive memory of system memory in computer system

(75) Inventors: Hung-Ta Pai, Ta-Jia Town (TW); Hung-Ming Lin, Hsin-Chu City (TW); Ming-Hao Liao, Hsin-Chu City (TW); Hung-Ju Huang, Taipei City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Silicon Integrated System Corp.

(21) Appl. No.: 10/175,897

(22) Filed: Jun. 21, 2002

(30) Foreign Application Priority Data
Nov. 27, 2001 (CN) 01139488.9

(51) Int. Cl. G06F 13/00; G06F 12/02; G06F 13/14

(52) U.S. Cl. 345/543; 345/520

(57) ABSTRACT

A method and a computer system are provided for using a portion of a local memory of a graphics card as an extensive memory of a system memory. When the computer system is rebooted, a portion of a local memory of a graphics card is claimed as an extensive memory of the system memory, and the local memory excluding the extensive memory is claimed a new local memory by a driver of the graphics card. The driver of the graphics card reports the new local memory capacity to an operating system of the computer. Then, a new system memory capacity including the extensive memory and the original system memory is claimed by a chipset of the computer system and reported to a memory sizing command of BIOS. Finally, if a memory access request is within the address range of the extensive memory, the memory access request is transmitted to the graphics card through AGP/PCI bus.

### FIELD OF THE INVENTION

The present invention relates to a method for using a portion of a local memory of a graphics card as an extensive memory of a system memory in a computer system. The present invention also relates to a computer system for using a portion of a local memory of a graphics card as an extensive memory of a system memory.

### BACKGROUND OF THE INVENTION

Referring to FIG. 1, a typical computer system comprises a central processing unit (CPU) 120, a system memory 140, a graphics card 130 and a chipset 110, in which the chipset 110 is electrically interconnected therewith. In addition to the system memory 140, the computer system also comprises a local memory 160 of the graphics card 130. When a computer is booted, the CPU 120 executes a basic input/output system (BIOS) 150 stored in a read-only memory (ROM). The local memory 160 usually serves as a fame buffer for storing a frame of graphic data. Generally the memory size required for the frame buffer is relatively small. With the increasing demand on 3D graphing functions, the size of the local memory 160 increases because it serves not only as a frame buffer but also as a texture buffer, a Z buffer and/or other graphics-related buffers. As a result, the size for the local memory becomes larger than ever.

The texture buffer is used to store therein texture data correlating to the rendering details of a 3D scene. When a precise 3D scene is to be rendered, a large amount of texture data has to be processed, and thus a large memory size of the texture buffer is required. Likewise, the Z buffer is also required to be enlarged for storing therein increasing depth data of the scene.

However, most of the local memory is frequently idled except when a 3D graphics operation is executed. For example, in the case of word processing, only the simple 2D graphics operations are sufficient. Such idleness is not economical and wastes resources.

### SUMMARY OF THE INVENTION

It is an object of the present invention to provide a method for using a portion of a local memory of a graphics card as an extensive memory of a system memory.

It is another object of the present invention to provide a computer system for using a portion of a local memory of a graphics card as an extensive memory of a system memory.

In an embodiment of the present invention, when the computer system is rebooted, a portion of a local memory of a graphics card is claimed as an extensive memory of the system memory, and the local memory excluding the extensive memory is claimed a new local memory by a driver of the graphics card. The driver of the graphics card reports the new local memory capacity to an operating system of the computer. Then, a new system memory capacity including the extensive memory and the original system memory is claimed by a chipset of the computer system and reported to a memory sizing command of BIOS. Finally, if a memory access request is within the address range of the extensive memory, the memory access request is transmitted to the graphics card through AGP (Accelerated Graphics Port)/PCI (Peripheral Component Interconnect) bus.

In an embodiment, the new local memory capacity is claimed by a chipset of the computer system, and the new local memory capacity is claimed by a driver of the graphics card.

In an embodiment, when the memory access request is transmitted to the graphics card, the chipset correlates addresses in the extensive memory to those in the portion of the local memory claimed as the extensive memory.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a functional block diagram illustrating a typical computer system;

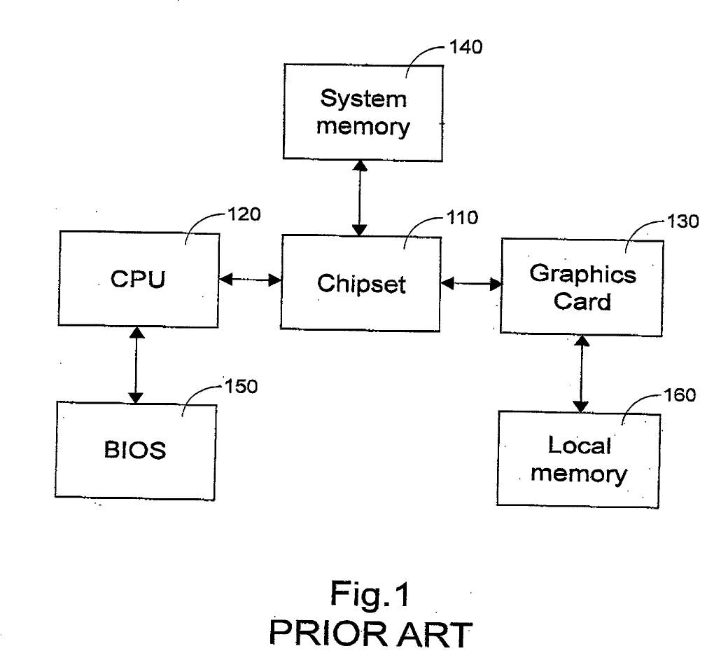

FIG. 2 schematically illustrates memory mapping of the extensive memory; and

FIG. 3 is a flowchart illustrating a process for processing memory access requests according to a preferred embodiment of the present invention.

### DETAILED DESCRIPTION OF THE PREFERRED EMBODIMENT

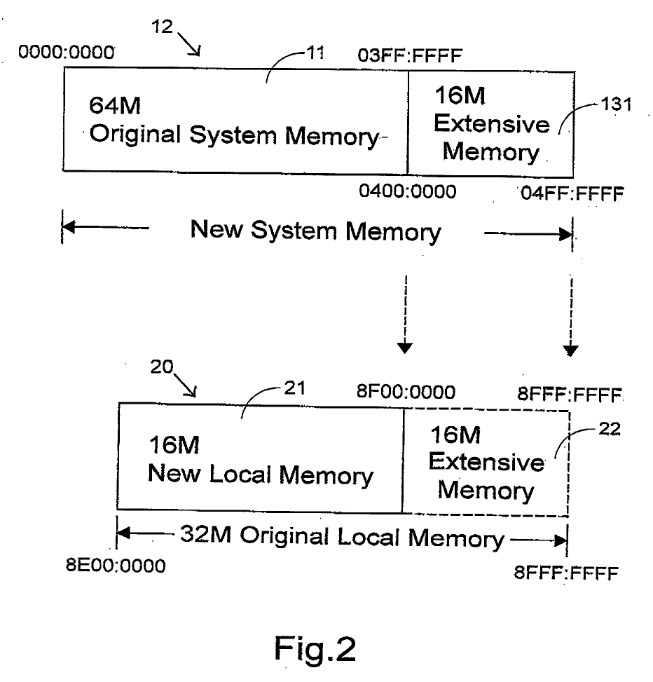

FIG. 2 schematically illustrates memory mapping of the extensive memory. For example, memory sizes of the original system memory 11 and the original local memory 20 are 64 M and 32 M, respectively. The addresses of original system memory 11 and the original local memory 20 range from 0000:0000 to 03FF:FFM, and from 81300:000 to 8FFF:FFFF, respectively. In accordance with the present invention, the original local memory 20 is divided into two parts 21 and 22. The part 22 is used as the extensive memory of the original system memory 11, and the remaining part 21 of the original local memory 20 is claimed as the new local memory. The original system memory 11 including the memory capacity of the extensive memory 22 is claimed as a new system memory 12. If half memory size of the original local memory 20, i.e. 16 M, is used as the extensive system memory 22, the memory size of the new system memory 12 is enlarged to 80M and thus its address range is extended to 04FF:FFFF. In such case, the memory size of the new local system memory 21 is reduced to 16 M, and its address is shrunk to 8EFF:FFFF. Although the access speed of the local memory is slower than that of the system memory, the access speed of the local memory is quicker than that of a hard disc. Therefore, the local memory is suitable for being used as the extensive memory of the system memory.

It is of course that a requirement for using a portion of the local memory to be the extensive memory is dependent on a user's demand. When the local memory is not in an idle condition, for example when a 3D graphics operation is executed, the local memory needs not to be used as the extensive memory of the system memory. In the case of an idle capacity for the operation of the graphics card, however, a portion of the local memory is used as the extensive memory of the system memory according to the present invention

Furthermore, the chipset 110 and the driver of the graphics card 130 in the present computer system need to be cooperated together. The basic input/output system (BIOS) of the graphics card 130 further has a driver to execute a memory sizing command. And, the basic input/output system (BIOS) of the computer system has an additional function for selecting the local memory of the graphics card 130 as the extensive memory of the system memory.

If a portion of the local memory of the graphics card 130 is required to be used as an extensive memory of a system memory, the computer system needs to be rebooted. The selecting function provided by the BIOS is employed for selecting the local memory of the graphics card 130 as the extensive memory of the system memory. When the memory sizing command is executed by the BIOS of the computer system, the chipset 110 detects not only the original system memory capacity but also the extensive memory capacity. Then, a new system memory capacity including the extensive memory and the original system memory is claimed by the chipset. At the moment when the original system memory capacity and the extensive memory capacity are detected, the chipset 110 also realize the corresponding address ranges of the original system memory and the extensive memory. In such way, when the CPU 120 sends a memory access request, according to the address range, the chipset 110 will redirect the memory access request to either the system memory 140 (e.g. DRAM) or the graphics card 130 through AGP/PCI bus.

Furthermore, during a startup operation of the computer system, the VGA BIOS of the graphics card 130 also execute the memory sizing command. The local memory capacity is detected by the graphics card 130, and the new local memory excluding the extensive memory capacity is reported to an operating system of the computer system. Therefore, when an application program is executed, only a portion of the local memory except for the extensive memory is used.

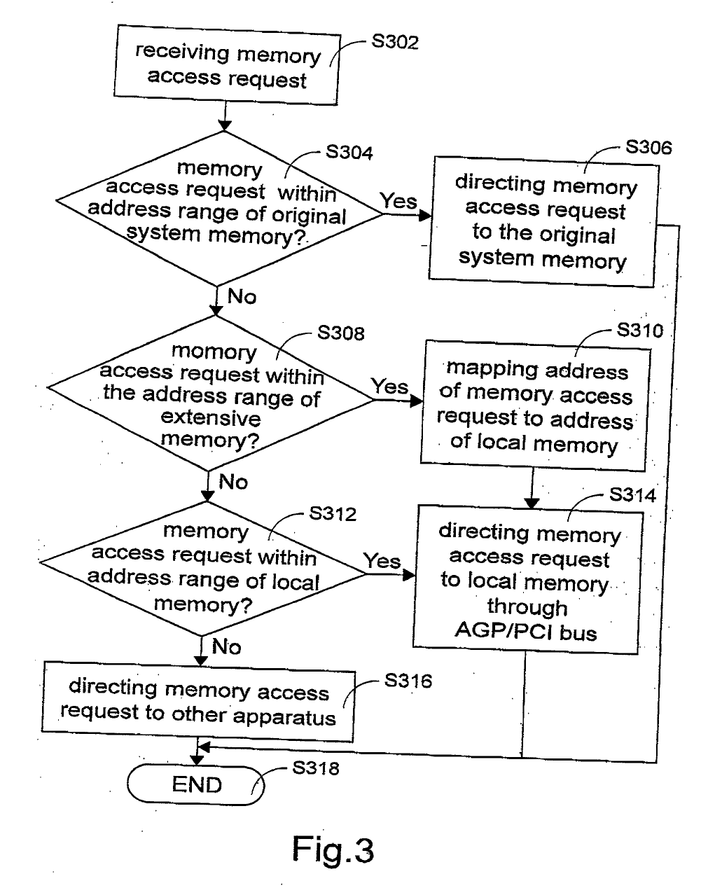

FIG. 3 is a flowchart illustrating a process for redirecting the memory access request to either the system memory 140 or the graphics card 130 by the chipset 110 when the CPU 120 sends a memory access request. The process comprises the following steps:

S302: receiving a memory access request;

S304: going to S306 if the memory access request is within the address range of the original system memory, otherwise going to S 308;

S306 redirecting the memory access request to the original system memory, and then going to S318;

S308: going to S310 if the memory access request is within the address range of the extensive memory, otherwise going to S312;

S310: mapping the address of the memory access request extensive to the address of the local memory, and then going to S314;

S312: going to S314 if the memory access request is within the address range of the local memory otherwise going to S316;

S314; redirecting the memory access request to the local memory through the AGP/PCI bus, and then going to S318;

S316: redirecting the memory access request to other apparatus such as a USB interface; and

S318: END.

Since a portion of a local memory is claimed as an extensive memory of a system memory when the local memory is idle, the performance of the computer system will be largely enhanced. Furthermore, since the access speed of the local memory is quicker than that of a hard disc, the local memory is suitable for being used as the extensive memory. The original system memory is thus enlarged without requiring an additional DRAM so as to be cost-effective.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for using a portion of a local memory of a graphics card as an extensive memory of a system memory in a computer system, said process comprising steps of:
rebooting said computer system;
claiming said portion of said local memory as said extensive memory of said system memory;
claiming said local memory excluding said extensive memory as a new local memory capacity, and reporting said new local memory capacity to an operating system;
claiming said system memory including said extensive memory as a new system memory capacity, and reporting said new system memory capacity to a memory sizing command of a basic input/output system (BIOS); and
transmitting a memory access request to said graphics card trough AGP (Accelerated Graphics Port)/PCI (Peripheral Component Interconnect) bus, if said memory access request is within the address range of the extensive memory.

2. The method according to claim 1 wherein said new local memory capacity is claimed by a chipset of said computer system.

3. The method according to claim 2 wherein when said memory access request is transmitted to said graphics card, said chipset correlates addresses in said extensive memory to those in said portion of said local memory claimed as said extensive memory.

4. The method according to claim 1 wherein said new local memory capacity is claimed by a driver of said graphics card.

5. A computer system for using a portion of a local memory of a graphics card as an extensive memory of a system memory, said computer system comprising:
means for claiming said portion of said local memory as said extensive memory of said system memory;
means for claiming said local memory excluding said extensive memory as a new local memory capacity, and reporting said new local memory capacity to an operating system;
means for claiming said system memory including said extensive memory as a new system memory capacity, and reporting said new system memory capacity to a memory sizing command of a basic input/output system (BIOS); and
means for transmitting a memory access request to said graphics card through AGP (Accelerated Graphics Port)/PCI (Peripheral Component Interconnect) bus, if said memory access request is within the address range of the extensive memory.

6. The computer system according to claim 5 wherein said means for claiming said new local memory capacity is included in a chipset of said computer system.

7. The computer system according to claim 5 wherein said means for claiming said new local memory capacity is included in said graphics card.
